(19) United States
(12) Patent Application Publication
(10) Pub. No.: US 2004/0073650 A1
(43) Pub. Date: Apr. 15, 2004

(54) Resource management method in label switching network

(76) Inventor: Mitsuhiro Nakamura, Kawaski (JP)

Correspondence Address: KATTEN MUCHIN ZAVIS ROSENMAN, 575 MADISON AVENUE, NEW YORK, NY, 10022-2585, US

(21) Appl. No.: 10/664,635

(22) Filed: Sep. 18, 2003

(30) Foreign Application Priority Data
Sep. 20, 2002 (JP) 2002-275806

(51) Int. Cl. G06F 15/173

(52) U.S. Cl. 709/223; 709/225

(57) ABSTRACT

A reservation path optimization system for optimizing a reservation path between specified nodes configuring a network includes a reservation path setting module for setting the reservation path and a bandwidth for establishing a predetermined session between specified nodes, and a reservation path re-setting module for periodically re-setting the reservation path on the basis of the bandwidth set by the reservation path setting module.

### BACKGROUND OF THE INVENTION

The present invention relates to a technology for managing resources in a label switching network, particularly in a MPLS (Multi Protocol Label Switching) network.

A mechanism for assuring a QoS (Quality of Service) is classified into a resource allocation system and a priority control system. The resource allocation system is that a required link capacity is exclusively allocated to an individual session. The priority control system is that a queue for forwarding packets in accordance with a level for assuring the QoS is provided, and the packets are queued up on the basis of priorities of the respective sessions on the premise that the network as a whole has a sufficient allowance in its resources.

The resource allocation system is advantageous for as strict assurance of QoS, however, the priority control system is superior to the resource allocation system in terms of facilitating the processing. The priority control system has hitherto been a general system in the conventional IP network. It is, however, considered that the resource allocation system capable of coping with congestion will gain a larger spread as a traffic for business uses increases. The resource allocation system has a possibility in which an access might be rejected due to a deficiency of the resources when actually performing communications, and is therefore desired to have a pre-reservation function. As a matter of fact, a multiplicity of systems are going to implement the pre-reservation function (NTTAS Institute, NS Institute, KDDI, etc.).

On the other hand, TE (Traffic Engineering) over MPLS aiming at effectively utilizing the network resources is under the examination. Herein, a concept of TE will be discussed referring to FIG. 25. As shown in FIG. 25, an MPLS network is configured by nodes and links. The nodes are classified into edge nodes (which will hereinafter be called edges in some cases) a, c, e, f connected directly to the outside and core codes b, d that are not connected to the outside. In a general type of IP network, a node for forwarding the packet next is determined each time the node receives the packet. According to the MPLS network, however, a path (LSP (Label Switched Path)) is established (set) between the respective edge nodes, and, when receiving the packet from the outside, the LSP is allocated on a tuple-basis (session-basis) containing a source address and a source port of a source (origin) node, a destination address and a destination port of a destination node, wherein the packets of the same session take the same LSP. In this case, each of the nodes for routing determines a forward node on the basis of an LSP number allocated by the edge node. In an example shown in FIG. 25, two routes a-b-c and a-d-c are available as LSPs between the nodes a-c. Then, a link between the nodes a-d might be shared with the LSP across the nodes a-d-f.

In the network where the resource reservation is made, a bandwidth is determined for every LSP, and an LSP having an unoccupied bandwidth required is searched for when starting the session. The bandwidth of each LSP is dynamically fluctuated based on the traffic, whereby an efficient operation can be attained. This is known as traffic engineering (TE).

If a traffic between the nodes a-f is large, the bandwidth of the link between the a-d is allocated not to the LSP across a-d-c but to the LSP across a-d-f, thereby improving an activity efficiency of the network resources.

The existing TE does not take the pre-reservation of the resources into consideration and can not be applied as it is to the network adopting a reservation system. A design for a reservation-based traffic enables actualization of a more efficiency network resource management than by the prior art.

Next, an LSP management by a network resource management server (NMS) will be explained referring to FIG. 25. In the general network, the edge node allocates the LSP of the session. In the case of fluctuating the bandwidths of the LSPs by TE, it is required that a state of the traffic in the whole network be grasped and unified control be performed. Hence, there is proposed a method by which the NMS is disposed in the network and manages the entire LSPs batchwise. The NMS system has a merit of facilitating policy control and accounting control as well.

The NMS system will be outlined. The NMS manages the whole bandwidths and unoccupied bandwidths of the LSPs within the MPLS network. A user accesses the NMS when starting the session and notifies the NMS of an address of a correspondent terminal and a required bandwidth. The NMS seeks for the LSPs capable of ensuring the notified bandwidth and, if none of such capable LSPs exist, rejects the access. The NMS, if there is the LSP that meets the condition, notifies each of the nodes on the route of this LSP, of a session number.

Further, a technique capable of efficiently allocating the communication resources is that the communication bandwidths ensured for transmitting information are managed in a way that divides them into fixed bandwidths and fluctuating bandwidths (refer to, e.g., a patent document 1: Japanese Patent Laid-Open Publication No.10-303932).

It is an object of the present invention to actualize the traffic engineering (TE) taking the reservation-based traffic into consideration on the premise that the network management server manages the label switched paths (LSPs) (which are particularly the LSPs of MPLS). In the present situation, only the on-communication sessions are managed, and, if admitting the reservations, there arises a necessity of considering prospective sessions. In this case, there must be a leaping increase in the number of sessions to be managed, and hence an efficient session management and an efficient path management are required of the system. It is impossible in terms of a throughput that an algorithmic process for the TE is executed each time the reservation request is made, and therefore a problem is how the traffic engineering (TE) is carried out with no excessive load on the throughput by separating admission control (a judgement as to whether the reservation is acceptable or not must be done when making the reservation request) and a scheduling algorithm for setting the path from each other.

### SUMMARY OF THE INVENTION

To accomplish the object given above, according to one aspect of the present invention, a resource management method for managing resources in a label switching network, includes retaining a bandwidth of an on-reservation session and a bandwidth of an on-communication session, and executing periodical re-setting of a path with respect to the bandwidth occupied by the on-reservation session.

According to the present invention, a resource activity efficiency is improved by executing the re-routing including the on-reservation bandwidths, as compared with networks that do not utilize the present method.

The resource management method in the label switching network may further include recording a failure count, for a fixed period, of a link causing a failure (NG) in a reservation request in a previous period, and fluctuating a weight of the link that tends to cause the failure (NG) on the basis of a history of the failure count. Thus, the resource activities in the network can be averaged by increasing a weight of the link having a larger failure count due to a deficiency of the resources.

The resource management method in the label switching network may further include fluctuating a re-setting period of the path in accordance with the reservation request failure count. This contrivance enables the re-setting to be executed with a more preferable period.

According to another aspect of the present invention, a reservation path optimization system for optimizing a reservation path between specified nodes configuring a network, includes a reservation path setting module for setting the reservation path and a bandwidth for establishing a predetermined session between specified nodes, and a reservation path re-setting module for periodically re-setting the reservation path on the basis of the bandwidth set by the reservation path setting module.

With this architecture, the resource activity efficiency is improved by executing the re-routing including the on-reservation bandwidths, as compared with networks that do not utilize the present method.

The reservation pathoptimization system may further include a module for fluctuating the period. This contrivance enables the re-setting to be executed with a more preferable period.

In the reservation path optimization system, the network may be an MPLS network, and the reservation path may be LSP. Further, the path between the specified nodes is a path between, e.g., edge nodes.

According to a further aspect of the present invention, a reservation path optimization method for optimizing a reservation path between specified nodes configuring a network, includes setting the reservation path and a bandwidth for establishing a predetermined session between specified nodes, and periodically re-setting the reservation path on the basis of the bandwidth set by the reservation path setting.

According to the present invention, an emphasis is put on such a point that it is difficult to change the route of the on-communication session, however, the route of the on-reservation session can be easily changed simply by processing on a memory, wherein a routing algorithmic process is to be re-executed aiming at the bandwidth occupied by the on-reservation session. FIG. 26 illustrates this concept. The conventional method is that a capacity of the LSP is increased corresponding to a request, and, at a stage where the capacity can not be increased any more, the capacities are re-allocated to the bandwidths excluding the bandwidths occupied at that point of time (there are multiple variations in re-allocating). FIG. 27 shows contents of the link bandwidths in the case of providing the link bandwidths and a reservation service in the prior art.

### BRIEF DESCRIPTION OF THE DRAWINGS

FIG. 1 is an explanatory diagram showing an outline of an architecture of a reservation path optimization system by way of one embodiment of the present invention;

FIG. 2 is an explanatory diagram showing a structure of link-mapping data;

FIG. 3 is an explanatory diagram showing a structure of LSP-mapping data;

FIG. 4 is an explanatory diagram showing a structure of session data;

FIG. 5 is an explanatory diagram showing contents of respective categories of data in an initial status;

FIG. 6 is an explanatory flowchart showing an operation of the reservation path optimization system in one embodiment of the present invention;

FIG. 7 is an explanatory diagram showing unoccupied bandwidths of respective links;

FIG. 8 is an explanatory diagram showing contents of the respective categories of data after making a (first) session reservation;

FIG. 9 is an explanatory diagram showing the unoccupied bandwidths and reservation bandwidths of the respective links;

FIG. 10 is an explanatory diagram showing the unoccupied bandwidths and the reservation bandwidths of the respective links;

FIG. 11 is an explanatory diagram showing contents of the respective categories of data after making a (second) session reservation;

FIG. 12 is an explanatory flowchart showing a period bandwidth allocation process;

FIG. 13 is an explanatory diagram showing a period determining table;

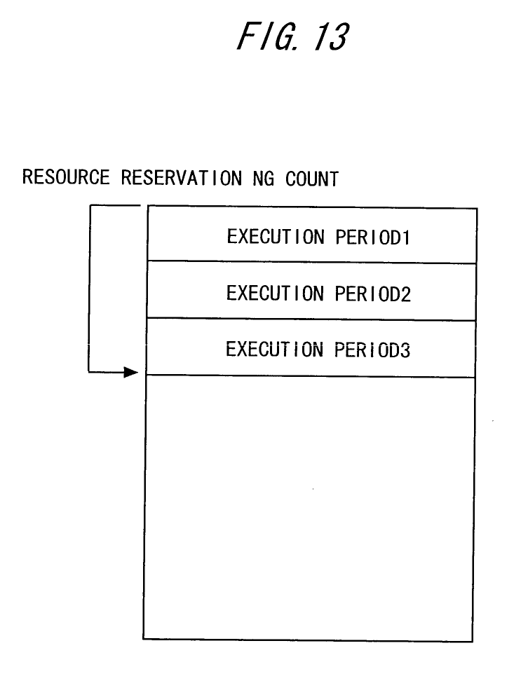

FIG. 14 is an explanatory diagram showing the unoccupied bandwidths of the respective links;

FIG. 15 is an explanatory diagram showing the unoccupied bandwidths and the reservation bandwidths of the respective links;

FIG. 16 is an explanatory diagram showing contents the respective categories of data after re-setting;

FIG. 17 is an explanatory diagram showing contents of the respective categories of data after re-setting a session (bandwidth 5);

FIG. 18 is an explanatory diagram showing the unoccupied bandwidths and the reservation bandwidths of the respective links;

FIG. 19 is an explanatory diagram showing the unoccupied bandwidths and the reservation bandwidths of the respective links;

FIG. 20 is an explanatory diagram showing contents of the respective categories of data after re-setting a session (bandwidth 3);

FIG. 21 is an explanatory diagram showing contents of the respective categories of data after re-setting a session (bandwidth 6);

FIG. 22 is an explanatory flowchart showing a process of starting an on-reservation session;

FIG. 23 is an explanatory flowchart showing a process of terminating the on-reservation session;

FIG. 24 is an explanatory diagram showing an example where the reservation path optimization system is applied to a real system;

FIG. 25 is an explanatory diagram illustrating a concept of TE (Traffic Engineering);

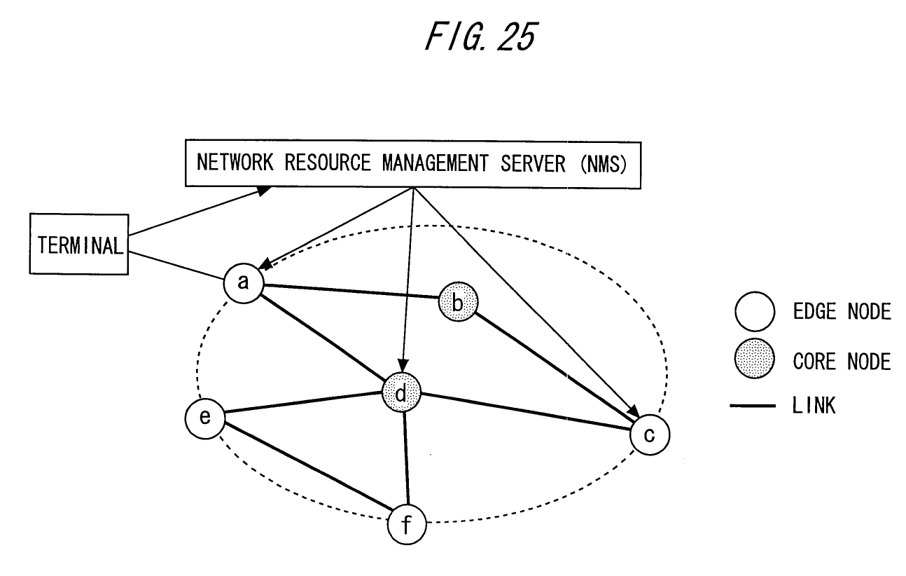

FIG. 26 is an explanatory diagram illustrating a basic concept of the present invention; and

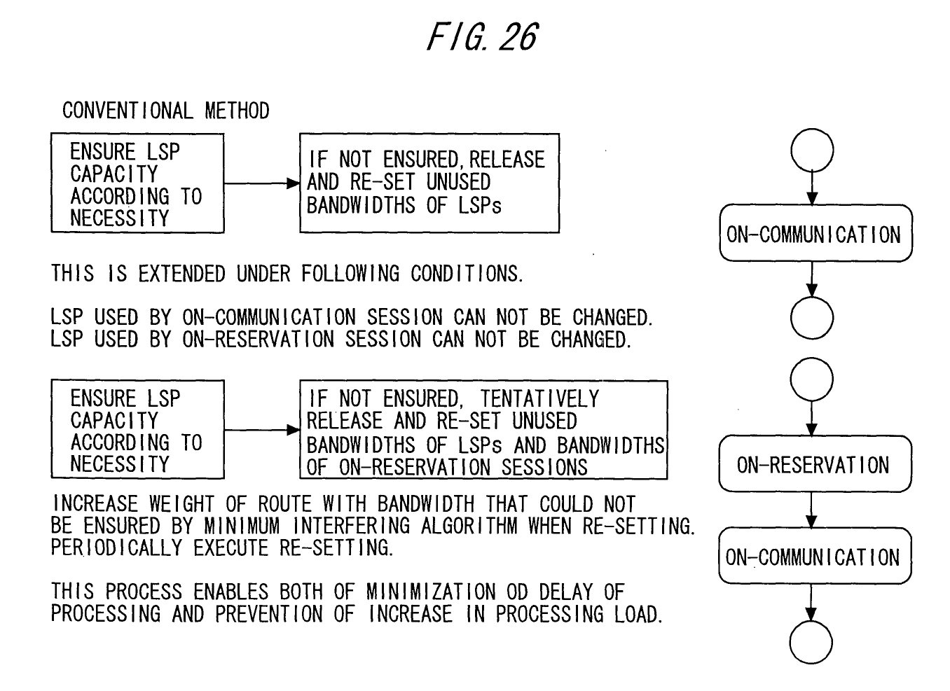

FIG. 27 is a diagram showing contents of the link bandwidths in the case of providing link bandwidths and a reservation service in the prior art.

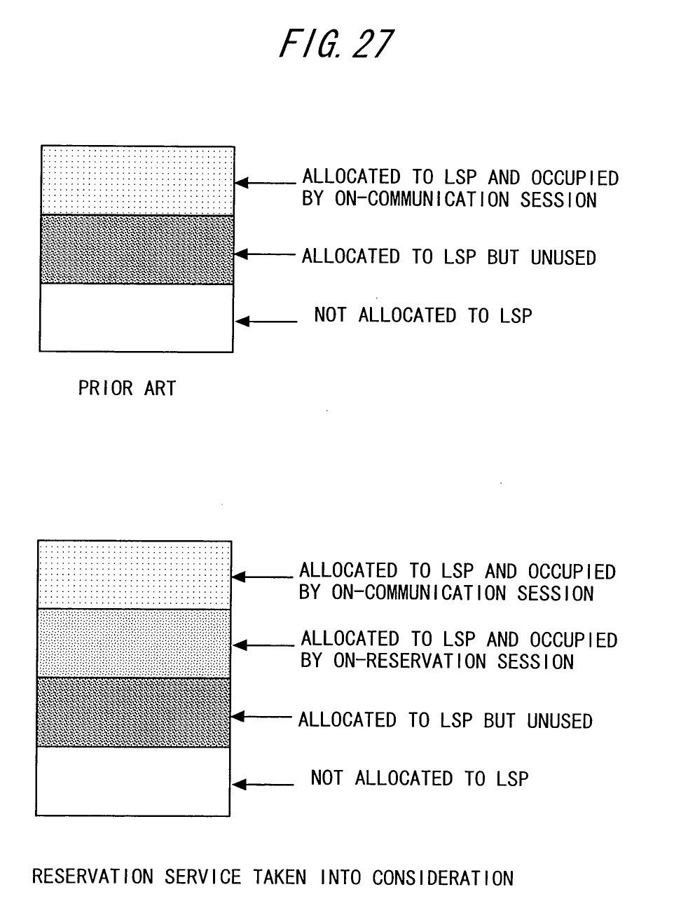

### DETAILED DESCRIPTION OF THE PREFERRED EMBODIMENTS

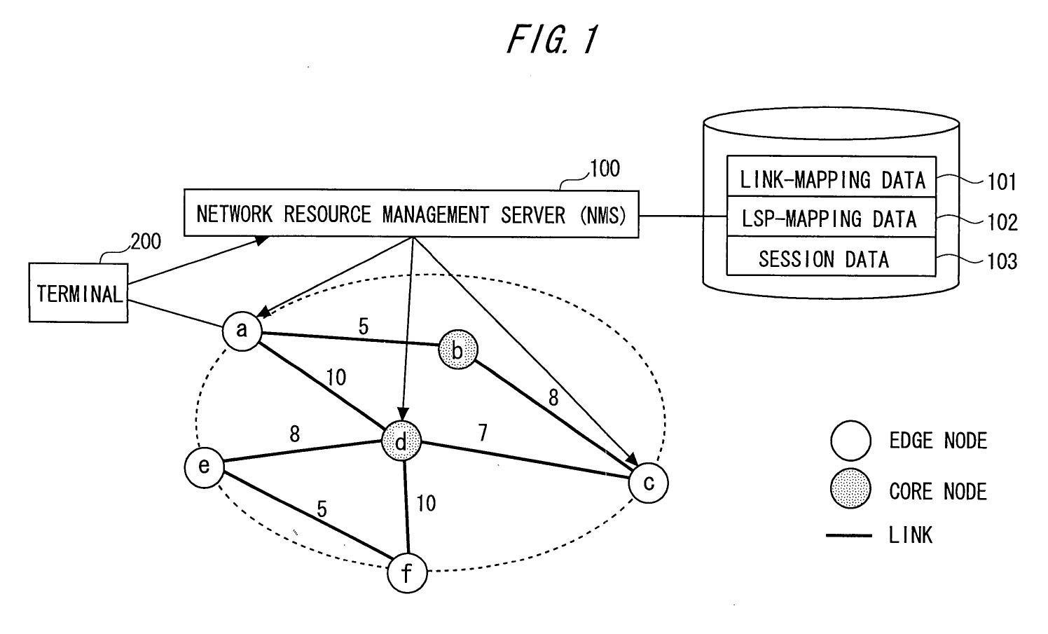

A reservation path optimization system as one embodiment of the present invention will hereinafter be discussed with reference to the accompanying drawings. FIG. 1 is an explanatory diagram showing an outline of a system architecture of the reservation path optimization system in one embodiment of the present invention.

The reservation path optimization system in this embodiment includes an MPLS network, a network resource management server (which will hereinafter be abbreviated to NMS) 100 and terminals 200.

The MPLS network is as shown in FIG. 1, configured by nodes “a” through “f” and links a-b through e-f. The nodes are classified into edge nodes (which might hereinafter be simply called “edges”) a, c, e, f connected directly to the outside and into core nodes b, d that are not connected thereto. Note that the number of the nodes and the number of the links can be set to proper numerical values.

A link capacity indicated by a numeral in FIG. 1 is allocated to each link. For example, the numeral 5 given on the ink a-b between the nodes “a” and “b” indicates that the link capacity of the link a-b is 5. Other numerals have the same connotation.

The NMS 100 is a server for managing whole bandwidths and unoccupied bandwidths for LSPs (Label Switched Paths) within the MPLS network. The NMS 100 retains link mapping data 101, LSP mapping data 102 and session data 103 for managing the bandwidths on a hard disk device, etc.

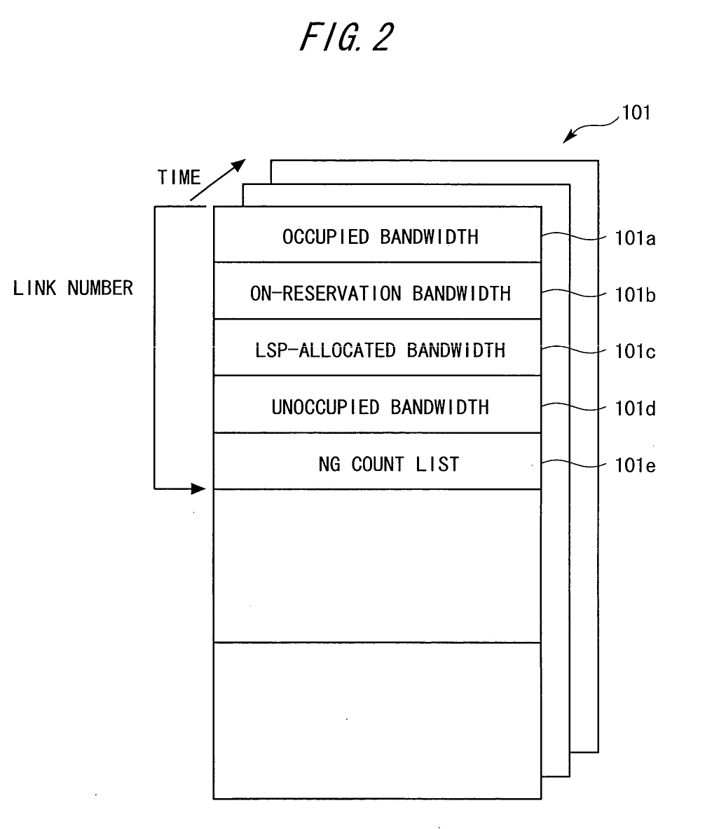

The link mapping data 101 consists of, as shown in FIG. 2, items such as an occupied bandwidth 101a, an on-reservation bandwidth 101b, an LSP-allocated bandwidth 10c, an unoccupied bandwidth 101d and an NG (no good; failure) count list 101e. The NMS 100 retains the link mapping data 101 for every link (each link number).

In an initial status after initialization has been done, “0” is set in each of the occupied bandwidth 101a, the on-reservation bandwidth 101b and the LSP-allocated bandwidth 101c. Further, a link capacity is set in the unoccupied bandwidth 101d.

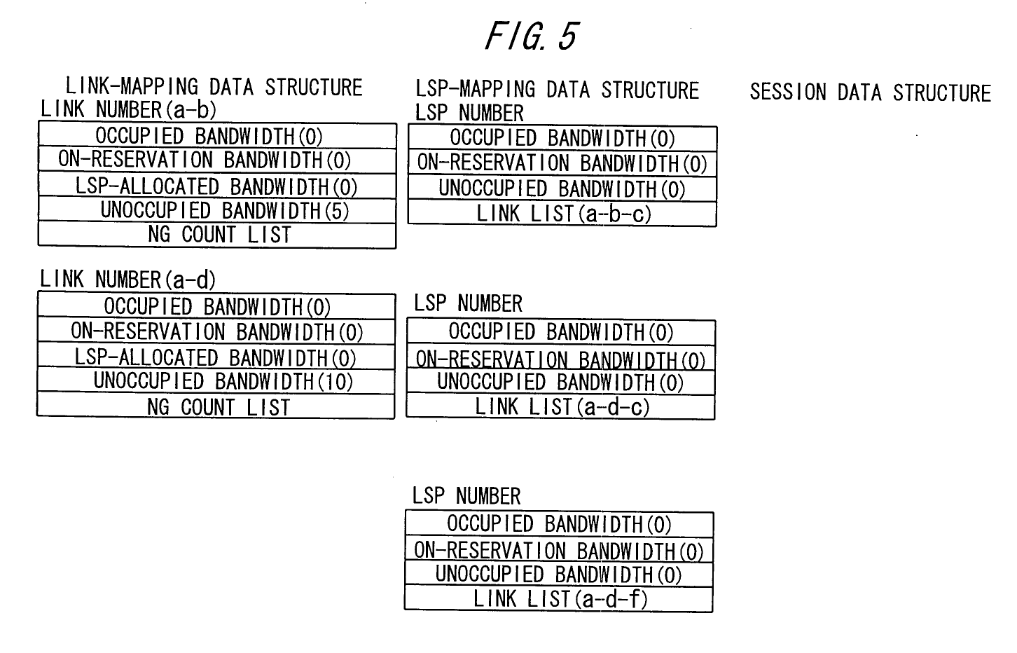

The link-mapping data 101 mapping to the link a-b in the initial status is shown in an upper part of a left row in FIG. 5. The link mapping data 101 mapping to the link a-d in the initial status is shown in a lower part of the left row in FIG. 5.

The link-mapping data 101 is retained per unit time (supposing that a reservation unit time is set to, e.g., 15 minutes, this time interval starts such as 00:00 to 00:15 on XX day in XX month).

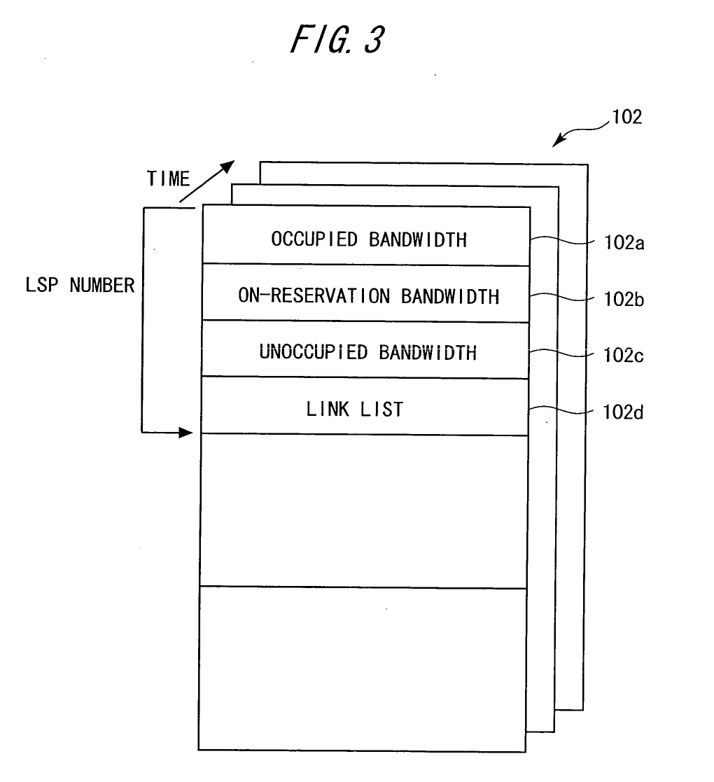

The LSP-mapping data 102 consists of, as shown in FIG. 3, items such as an occupied bandwidth 102a, an on-reservation bandwidth 102b, an unoccupied bandwidth 102c and a link list 102d. The NMS 100 generates the LSP for all the thinkable routes from combinations arbitrary two edge nodes, and retains the LSP-mapping data 102 mapping to each LSP (each LSP number).

In the initial status after the initialization has been done, “0” is set in each of the unoccupied bandwidth 102c, the on-reservation bandwidth 102b and the occupied bandwidth 102a. Further, an aggregation of links that build up an LSP mapping thereto is set in the link list 102d.

The LSP-mapping data 102 mapping to a route a-b-c in the initial status is shown in an upper part of a right row in FIG. 5. The LSP-mapping data 102 mapping to a route a-d-c in the initial status is shown in a lower part of the right row in FIG. 5.

The LSP-mapping data 102 is retained per unit time (supposing that a reservation unit time is set to, e.g., 15 minutes, this time interval starts such as 00:00 to 00:15 on XX day in XX month).

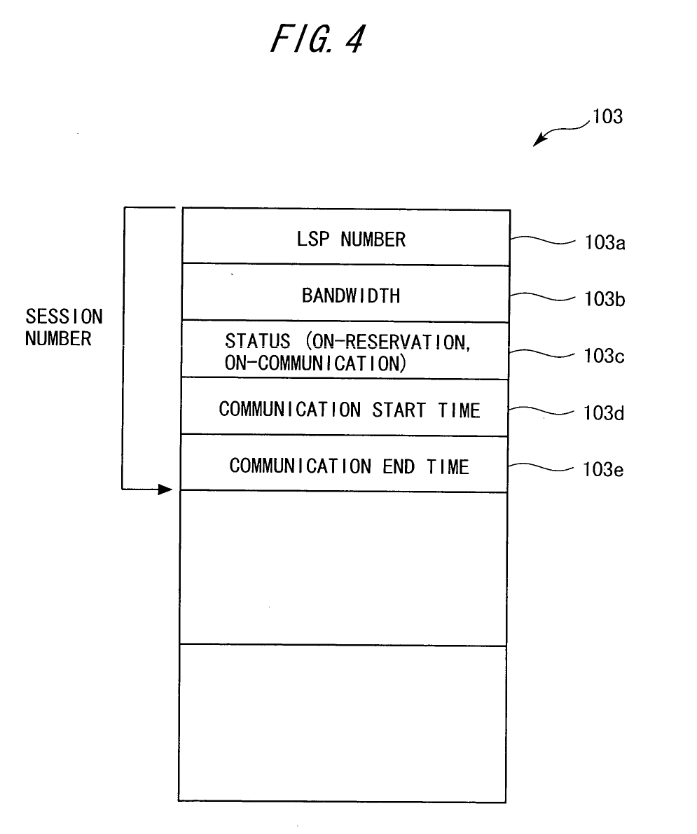

The session data 103 consists of, as shown in FIG. 4, items such as an LSP number 103a, a bandwidth 103b, a status (on-reservation status or on-communication status) 103c, a communication start time 103d and a communication end time 103e. The NMS 100 retains the session data 103 for every session (each session number) Note that the session data 103 is not yet generated in the initial status after the initialization has been done (see FIG. 5).

Next, an outline of operation of the reservation path optimization system having the architecture described above will be explained.

(1) When making a request for a reservation, an LSP having an unoccupied bandwidth equal to or larger than a requested bandwidth is selected among the LSPs between the requested edge nodes, and the requested bandwidth is shifted to an on-reservation bandwidth from the unoccupied bandwidth.

(2) If the reservation request becomes successful, the LSP number 103a and the bandwidth 103b in the session-mapping data 103 are set. Further, [on-reservation] is set in the status 103c.

(3) If there does not exist the LSP that meets the condition, the necessary bandwidth is incremented. This incremented bandwidth is transferred to the link (LSP)-allocated bandwidth 101c from the unoccupied bandwidth 101d of each of the links building up this LSP.

(4) If the unoccupied bandwidth 101d of the link does not contain the bandwidth that can be incremented, a value in the NG count 101e of the link-mapping data 101 of that link is incremented by “1”, and NG is repeated.

(5) When reaching a communication start time of the on-reservation session, a start notice is sent to the node (router) that is linked to a target LSP, and [on-communication] is set in the status 103c. Further, the on-reservation bandwidth 102b is shifted to the on-communication bandwidth 102a in the target LSP-mapping data 102.

(6) When reaching the communication end time of the on-communication session, an end notice is sent to a node (router) that is linked to the target LSP, and the session-mapping data 103 is initialized. Moreover, the on-communication bandwidth 102 is shifted to the unoccupied bandwidth 102c in the target LSP-mapping data 102.

(7) LSP resetting based on a minimum interfering algorithm is executed periodically or just when a predetermined NG count is reached.

(8) In the minimum interfering algorithm, a weight “n” is, based on a history of the NG count, set larger as the NG count increases and smaller as it decreases. An execution period of the minimum interfering algorithm is determined, based on a fixed standard, to be shorter as the NG count becomes larger and longer as it becomes smaller.

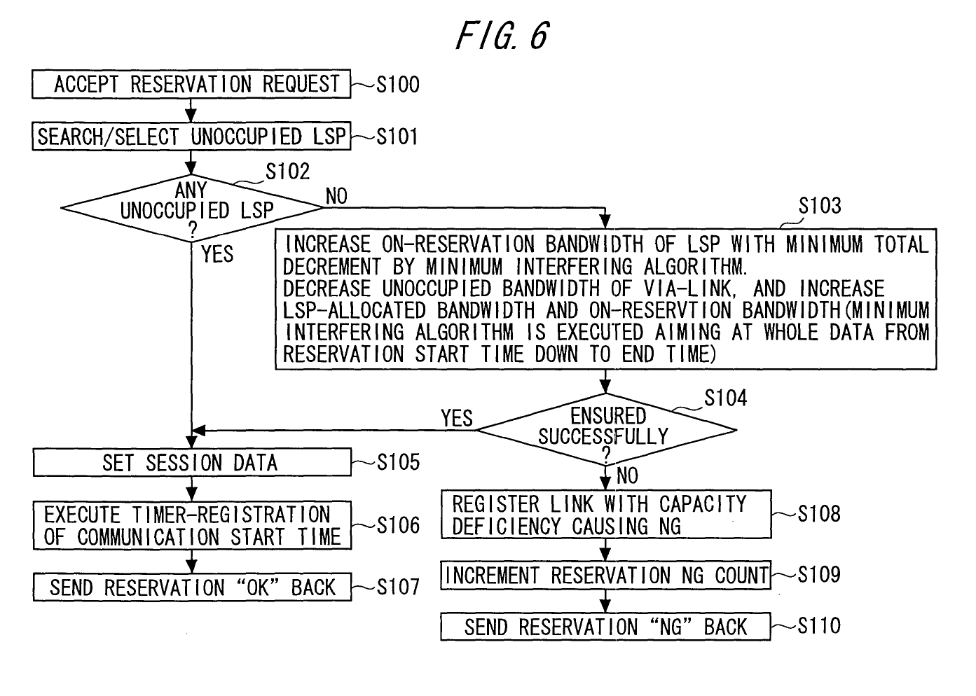

Next, the operation of the reservation path optimization system having the architecture described above will be described in depth with reference to the drawings. FIG. 6 is an explanatory flowchart showing the operation of the reservation path optimization system. Explained first is an operation for setting a reservation of a session of a bandwidth 3 between the nodes a-c in the MPLS network shown in FIG. 1.

Upon receiving an input of a reservation request (for reserving the session of the bandwidth between the nodes a-c) from the terminal 200, the NMS 100 accepts this reservation request (S100), and searches for and selects an unoccupied LSP (S101).

For instance, the NMS 100 refers to the unoccupied bandwidth 102c in the LSP-mapping data 102 (mapping to a route on which two end nodes are the node “a” and the node “c”), and judges whether or not there exists the LSP-mapping data 102 that meets this relationship: the unoccupied bandwidth 102c>the reservation-requested bandwidth 3 (S102).

Herein, the initialization being done, “0” is set the unoccupied bandwidths 102c in all the LSP-mapping data 102. Therefore, the NMS 100 judges that none of the LSPs are unoccupied (S102: No). When judging that there is no unoccupied LSP, the NMS 100 seeks, based on the minimum interfering algorithm, for such a route as to have a minimum total decrement.

Herein, referring back to FIG. 1, what can be considered as the reservation-requested route between the nodes a-c is two ways of a route a-b-c and a route a-d-c. Supposing that the reservation-requested bandwidth 3 is allocated to the route a-b-c, maximum usable capacities between the respective nodes are given as follows. The capacity between the nodes a-c=7, the capacity between the nodes a-e=8, the capacity between the nodes a-f=10, the capacity between the nodes c-e=7, the capacity between the nodes c-f=7, and the capacity between the nodes e-f=8, wherein a total capacity is added up to 47. This indicates that the total capacity before the reservation-requested bandwidth 3 is allocated to the route a-b-c is 47, and hence the total decrement is 0.

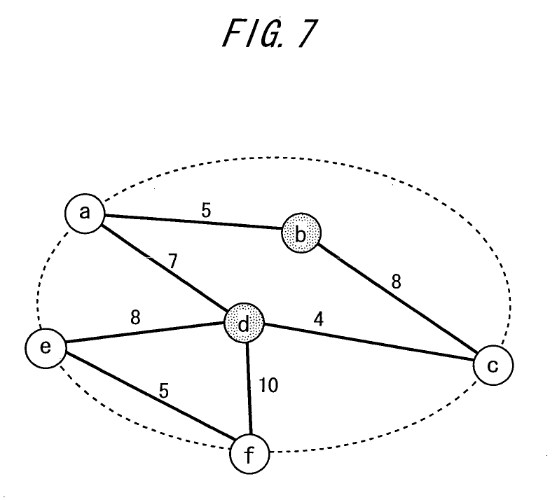

On the other hand, if the reservation-requested bandwidth 3 is allocated to the other route a-d-c, the unoccupied bandwidths of the respective links are given as shown in FIG. 7. In this case, the maximum usable capacities between the respective nodes are given as follows. The capacity between the nodes a-c=5, the capacity between the nodes a-e=7 the capacity between the nodes a-f=7, the capacity between the nodes c-e=4, the capacity between the nodes c-f=5, and the capacity between the nodes e-f=8, wherein the total capacity is added up to 36. This indicates that the total capacity before the reservation-requested bandwidth 3 is allocated to the route a-b-c is 47, and hence the total decrement is 11.

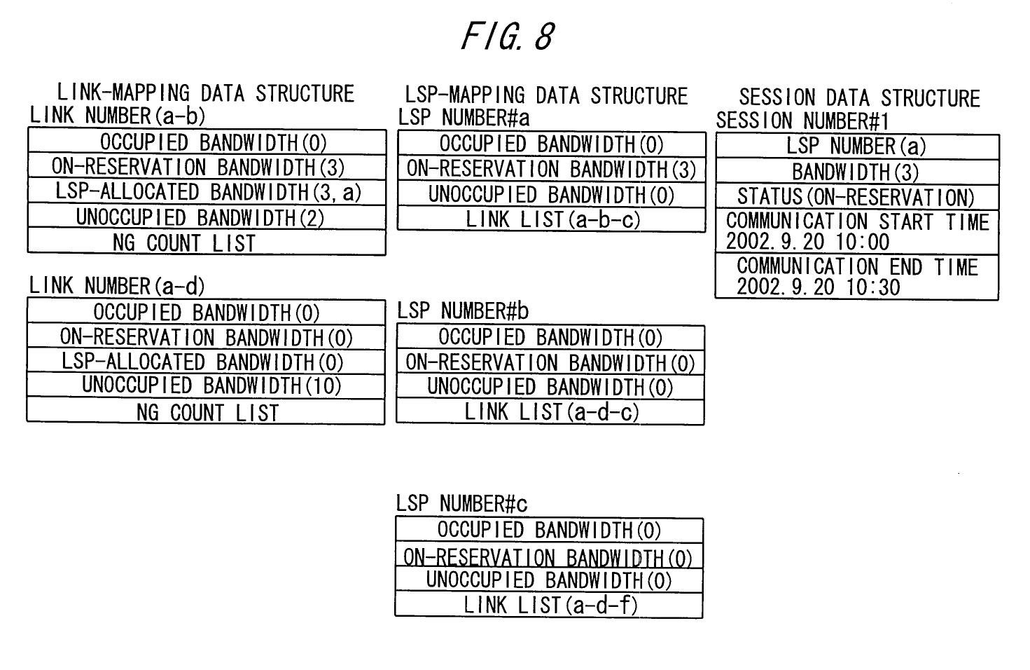

Accordingly, the NMS 100 obtains the route a-b-c as a route having the minimum total decrement. The NMS 100 sets (adds) the reservation-requested bandwidth 3 in the on-reservation bandwidth 102b in the LSP-mapping data 102 mapping to the obtained route a-b-c (corresponding to a reservation path) (see an upper part of a central row in FIG. 8) (S103).

Next, the NMS 100 subtracts the reservation-requested bandwidth 3 from the unoccupied bandwidth 101d in the link-mapping data 101 mapping to a via-link (which is a link, e.g., the link a-b of the links building up the route a-b-c) (see an upper part of a left row in FIG. 8) (S103).

Further, the NMS 100 adds the reservation-requested bandwidth 3 respectively to the LSP-allocated bandwidth 101c and the on-reservation bandwidth 101b in the link-mapping data 101 (see the upper part of the left row in FIG. 8) (S103). Through this operation, it follows that the bandwidth 3 reservation-requested by the terminal 200 is successfully ensured (S104: Yes).

The NMS 100, upon succeeding in ensuring the reservation-requested bandwidth 3, sets (generates) the session data 103 mapping to the LSP for the route a-b-c (see a right row in FIG. 8) (S105). For example, an LSP number (which is herein an LSP number #a) is set in the LSP number 103a in the session data 103 mapping to the LSP for the route a-b-c, the reservation-requested bandwidth 3 is set in the bandwidth 103b, and “on-reservation” is set in the status 103c, respectively (see the right row in FIG. 8). Further, the NMS 100 sets (timer registration) the communication start time 103d and the communication end time 103e in the session data 103 (S106). Upon a completion of the settings described above, the NMS 100 notifies the terminal 200 that the reservation is OK.

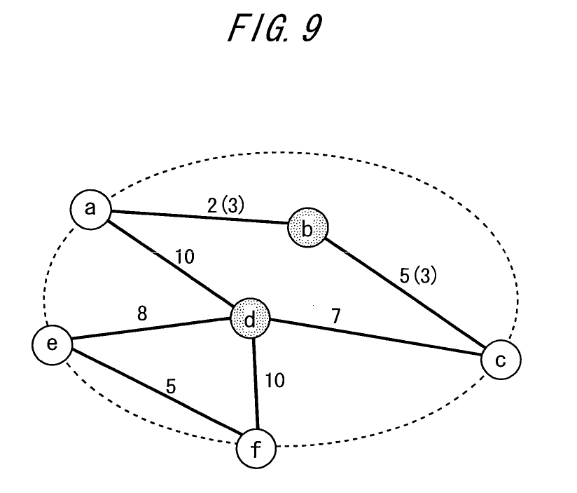

FIG. 9 shows the unoccupied bandwidths of the respective links after the session of the bandwidth 3 has been, as described above, reservation-set between the nodes a-c. The numeral 2 on the link a-b between the nodes a-b in FIG. 9 indicates that 2 (the link capacity of the link a-b is 5, and the reservation-requested bandwidth is 3) is set in the unoccupied bandwidth 101d of that link a-b. Further, (3) adjacent thereto shows that 3 (the reservation-requested bandwidth is 3) is set in the on-reservation bandwidth 101b of the same link a-b. Other numerals have the same connotation.

Next, an operation of further setting the reservation of the session of a bandwidth 5 between the nodes a-c after a completion of the reservation setting of the setting of the bandwidth 3 between the nodes a-b, will be described referring to FIG. 6.

Upon receiving an input of a reservation request (for reserving the session of the bandwidth 5 between the nodes a-c) from the terminal 200 (or a different terminal), the NMS 100 accepts this reservation request (S100), and searches for and selects an unoccupied LSP (S101).

For example, the NMS 100 refers to the unoccupied bandwidth 102c in the LSP-mapping data 102 (mapping to a route on which two end nodes are the node “a” and the node “c”), and judges whether or not there exists the LSP-mapping data 102 that meets this relationship: the unoccupied bandwidth 102c>the reservation-requested bandwidth 5 (S102)

Herein, the initialization being done, “0” is set the unoccupied bandwidths 102c in all the LSP-mapping data 102. Therefore, the NMS 100 judges that none of the LSPs are unoccupied (S102: No). When judging that there is no unoccupied LSP, the NMS 100 seeks, based on the minimum interfering algorithm, for such a route as to have a minimum total decrement.

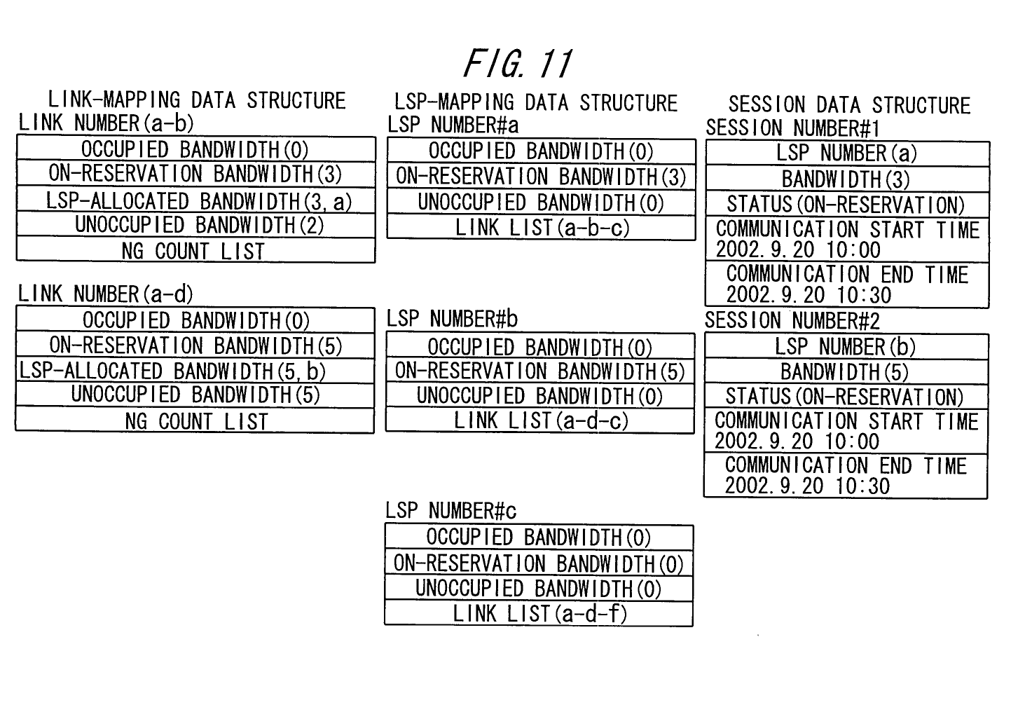

Herein, referring back to FIG. 1, what can be considered as the reservation-requested route between the nodes a-c is two ways of the route a-b-c and the route a-d-c. The route capable of ensuring the reservation-requested bandwidth 5 is only the route a-d-c. Hence, the NMS 100 sets (adds) the reservation-requested bandwidth 5 in the on-reservation bandwidth 102b in the LSP-mapping data 102 mapping to this route a-d-c (corresponding to a reservation path) (see a middle part of a central row in FIG. 11) (S103).

Next, the NMS 100 subtracts the reservation-requested bandwidth 5 from the unoccupied bandwidth 101d in the link-mapping data 101 mapping to a via-link (which is a link, e.g., the link a-d of the links building up the route a-d-c) (see a lower part of a left row in FIG. 11) (S103).

Further, the NMS 100 adds the reservation-requested bandwidth 5 respectively to the LSP-allocated bandwidth 101c and the on-reservation bandwidth 101b in the link-mapping data 101 (see the lower part of the left row in FIG. 11) (S103). Through this operation, it follows that the bandwidth 5 reservation-requested by the terminal 200 is successfully ensured (S104: Yes).

The NMS 100, upon succeeding in ensuring the reservation-requested bandwidth 5, sets (generates) the session data 103 mapping to the LSP for the route a-d-c (see a lower part of aright row in FIG. 11) (S105). For example, an LSP number (which is herein an LSP number #b) is set in the LSP number 103a in the session data 103 mapping to the LSP for the route a-d-c, the reservation-requested bandwidth 5 is set in the bandwidth 103b, and “on-reservation” is set in the status 103c, respectively (see the lower part of the right row in FIG. 11). Further, the NMS 100 sets (timer registration) the communication start time 103d and the communication end time 103e in the session data 103 (S106). Upon a completion of the settings described above, the NMS 100 notifies the terminal 200 that the reservation is OK.

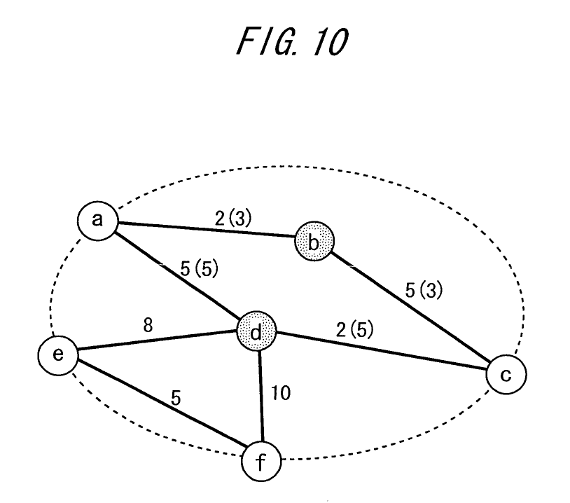

FIG. 10 shows the unoccupied bandwidth of the respective links after the session of the bandwidth 5 has been reservation-set in between the nodes a-c. The numeral 5 on the link a-d between the nodes a-d in FIG. 10 indicates that 5 (the link capacity of the link a-d is 10, and the reservation-requested bandwidth is 5) is set in the unoccupied bandwidth 101d of that link a-d. Further, (5) adjacent thereto shows that 5 (the reservation-requested bandwidth is 5) is set in the on-reservation bandwidth 101b of the same link a-d. Other numerals have the same connotation.

It is assumed that a reservation request (for reserving the session of the bandwidth 6 between the nodes a-f) has been inputted from the terminal 200 after the sessions of the band widths 3 and 5 have been reservation-set between the nodes a-c. The NMS 100 accepts this reservation request (S100), and searches for and selects an unoccupied LSP (S101).

For instance, the NMS 100 refers to the unoccupied bandwidth 102c in the LSP-mapping data 102 (mapping to a route on which two end nodes are the node “a” and the node “f”), and judges whether or not there exists the LSP-mapping data 102 that meets this relationship: the unoccupied bandwidth 102c>the reservation-requested bandwidth 6 (S102).

Herein, the initialization being done, “0” is set the unoccupied bandwidths 102c in all the LSP-mapping data 102. Therefore, the NMS 100 judges that none of the LSPs are unoccupied (S102: No). When judging that there is no unoccupied LSP, the NMS 100 seeks, based on the minimum interfering algorithm, for such a route as to have a minimum total decrement.

Herein, referring back to FIG. 1, reservation-requested route between the nodes a-f is only the route a-d-f. The NMS 100 tries to subtract the reservation-requested bandwidth 6 from the unoccupied bandwidth 101d in the link-mapping data 101 for a via-link (which is a link, e.g., the link a-d of the links building up the route a-d-f). However, 5 is set in the unoccupied bandwidth 101d in the link-mapping data 101 for the link a-d (see the lower part of the left row in FIG. 11), and it is therefore impossible to subtract the reservation-requested bandwidth 6. This results in a failure in ensuring the bandwidth 6 that has been reservation-requested by the terminal 200 (S104: No).

In this case, the NMS 100 registers the link (which is herein the link a-d) that is deficient of the capacity, which caused NG (S108), and adds, e.g., “1” to the NG count list (reservation NG count) in the link-mapping data 101 mapping to this link (S109). Upon a completion of the processes described above, the NMS 100 notifies the terminal 200 that the reservation has come to no good (NG) (S110).

According to this embodiment, a period-based bandwidth allocation process (reservation re-allocation process) is executed in order that the reservation request (for reserving the session of the bandwidth 6 between the nodes a-f) with NG of the reservation as described above, can be reservation-set. The execution of this period-based bandwidth allocation process enables the session of the bandwidth 6 to be further reservation-set between the nodes a-f even after the sessions of the bandwidths 3, 5 have been set between the nodes a-c.

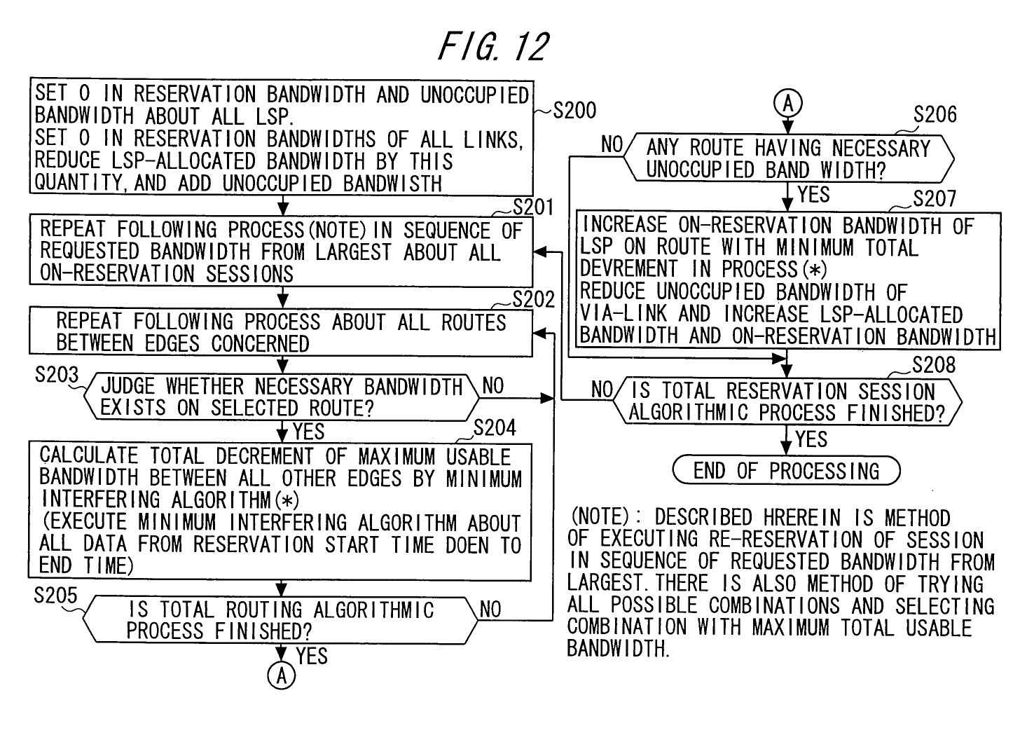

The period-based allocation process (reservation re-allocation process) will hereinafter be described with reference to the drawings. FIG. 12 is an explanatory flowchart of the period-based allocation process.

The period-based allocation process can be executed at a variety of timings such as a fixed period, etc. According to this embodiment, an execution period of the period-based allocation process is changed corresponding to a reservation failure (NG) count. The change of this execution period involves using a period determining table in which a resource reservation failure count (reservation NG count) and an execution period are registered mapping to each other.

The NMS 100 searches the period determining table for the execution period mapping to a total resource reservation NG count (as a total of the values of the NG count lists 101e in all the link-mapping data 101) within a fixed time, and executes the period-based allocation process (flowchart in FIG. 12) with this execution period searched for.

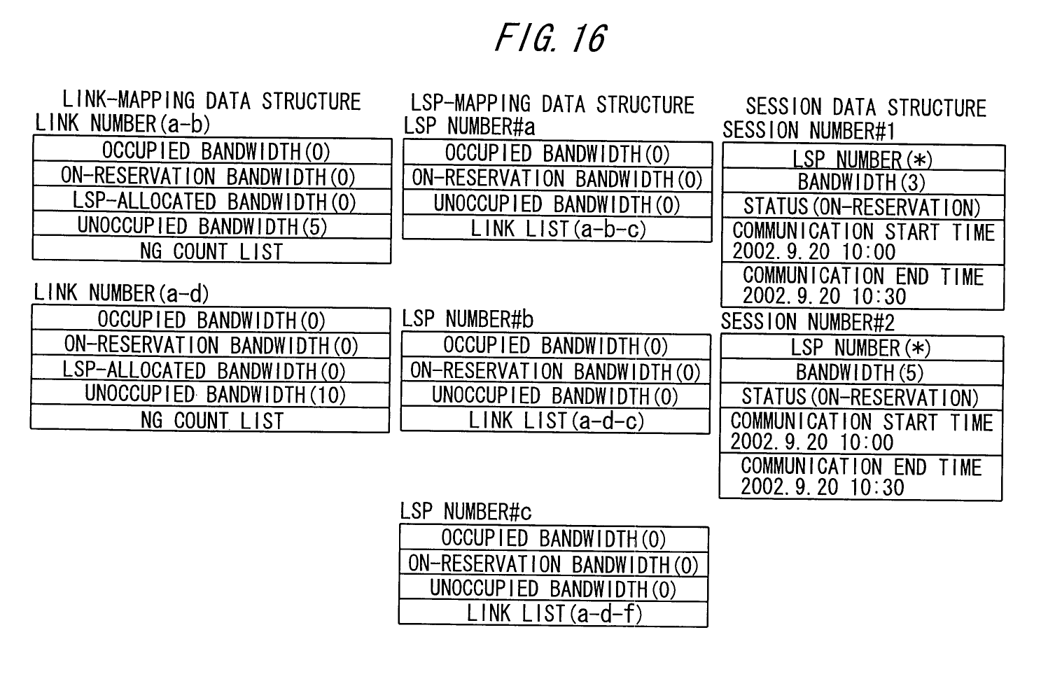

The NMS 100, when executing the period-based allocation process, sets “0” respectively in the reservation bandwidths 102b and the unoccupied bandwidths 102c in the whole LSP-mapping data 102 (see a central row in FIG. 16) (S200). Further, the NMS 100 sets “0” in the on-reservation bandwidths 101b in the whole link-mapping data 101 (see a left row in FIG. 16) (S200). Moreover, the NMS 100 subtracts the on-reservation bandwidth 101b (before “0” is set) from the LSP-allocated bandwidth 101c, and adds the on-reservation bandwidth 101b (before “0” is set) to the unoccupied bandwidth 101d (see he left row in FIG. 16) (S200). Through this process, the whole link-mapping data 101 and the whole LSP-mapping data 102 return to their initial statuses as shown in FIG. 16. Note that the session data at this stage remain unchanged as shown in the right row in FIG. 16.

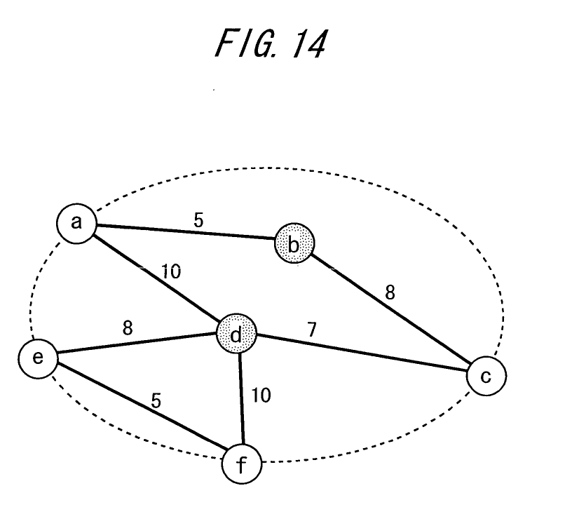

FIG. 14 shows the unoccupied bandwidth of the respective links at this stage. Referring to FIG. 14, the numeral 5 on the link a-b between the nodes a-b indicates that 5 is set in the unoccupied bandwidth 101d of this link a-b. Other numerals have the same connotation.

Next, the NMS 100 repeats the following process with respect to all the on-reservation sessions (which are herein the session of the bandwidth 3 and the session of the bandwidth 5 between the nodes a-c) in sequence of the requested bandwidth from the smallest to the largest (the session of the bandwidth 5 and the session of the bandwidth 3 in this sequence herein) (S201).

To start with, the NMS 100 repeats the following process for all the routes (the routes a-b-c and a-d-c) between the nodes a-c with respect to the session of the on-reservation bandwidth 5 (S202 through S205: No).

The NMS 100 judges whether or not a necessary unoccupied bandwidth exists on the selected route (e.g., a-b-c) (S203). For example, the NMS 100 refers to the unoccupied bandwidths 101d in the link-mapping data 101 for all the links building up the selected route a-b-c, and thus judges whether there is established this relationship: the unoccupied bandwidth 101d>=the on-reservation bandwidth 5. Referring to FIG. 14, there is established the relationship such as the unoccupied bandwidth 101d>=the on-reservation bandwidth 5, where the unoccupied bandwidth 101d (5 is set in the unoccupied bandwidth of the link a-b, and 8 is set in the unoccupied bandwidth of the link b-c) exists in the link-mapping data 101 for the links building up the route a-b-c. Therefore, the NMS 100 judges that the necessary unoccupied bandwidth exists (S203; Yes).

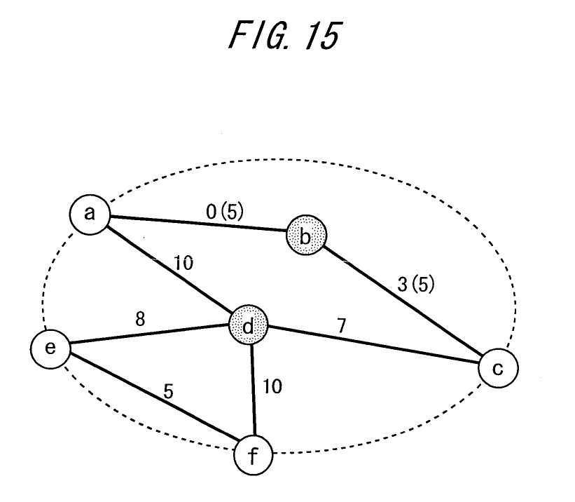

The NMS 100, when judging that the necessary unoccupied bandwidth exists, calculates a total decrement of a maximum usable bandwidth between all other edges on the basis of the minimum interfering algorithm (S204). Assuming herein that the on-reservation bandwidth 5 is allocated to the route a-b-c, the unoccupied bandwidths of the respective links are given as shown in FIG. 15. In this case, the maximum usable capacities between the respective nodes are given as follows. The capacity between the nodes a-c=7, the capacity between the nodes a-e=8, the capacity between the nodes a-f=10, the capacity between the nodes c-e=7, the capacity between the nodes c-f=7, and the capacity between the nodes e-f=8, wherein a total capacity is added up to 47. This indicates that the total capacity before the on-reservation bandwidth 5 is allocated to the route a-b-c is 47, and hence the total decrement is 0.

The NMS 100, the total route algorithmic process not being finished (S205: No), selects next a route a-d-c, and judges whether or not a necessary unoccupied bandwidth exists in this selected route a-d-c (S202, S203). For example, the NMS 100 refers to the unoccupied bandwidths 101d in the link-mapping data 101 for all the links building up the selected route a-d-c, and thus judges whether there is established this relationship: the unoccupied bandwidth 101d>=the on-reservation bandwidth 5. Referring to FIG. 14, there is established the relationship such as the unoccupied bandwidth 101d>=the on-reservation bandwidth 5, where the unoccupied bandwidth 101d (10 is set in the unoccupied bandwidth of the link a-d, and 7 is set in the unoccupied bandwidth of the link d-f) exists in the link-mapping data 101 for the links building up the route a-d-c. Therefore, the NMS 100 judges that the necessary unoccupied bandwidth exists (S203; Yes).

The NMS 100, when judging that the necessary unoccupied bandwidth exists, calculates a total decrement of a maximum usable bandwidth between all other edges on the basis of the minimum interfering algorithm (S204). Assuming herein that the on-reservation bandwidth 5 is allocated to the route a-d-c, the maximum usable capacities between the respective nodes are given as follows. The capacity between the nodes a-c=5, the capacity between the nodes a-e=5, the capacity between the nodes a-f=5, the capacity between the nodes c-e=2, the capacity between the nodes c-f=2, and the capacity between the nodes e-f=8, wherein a total capacity is added up to 27. This indicates that the total capacity before the on-reservation bandwidth 5 is allocated to the route a-d-c is 47, and hence the total decrement is 20.

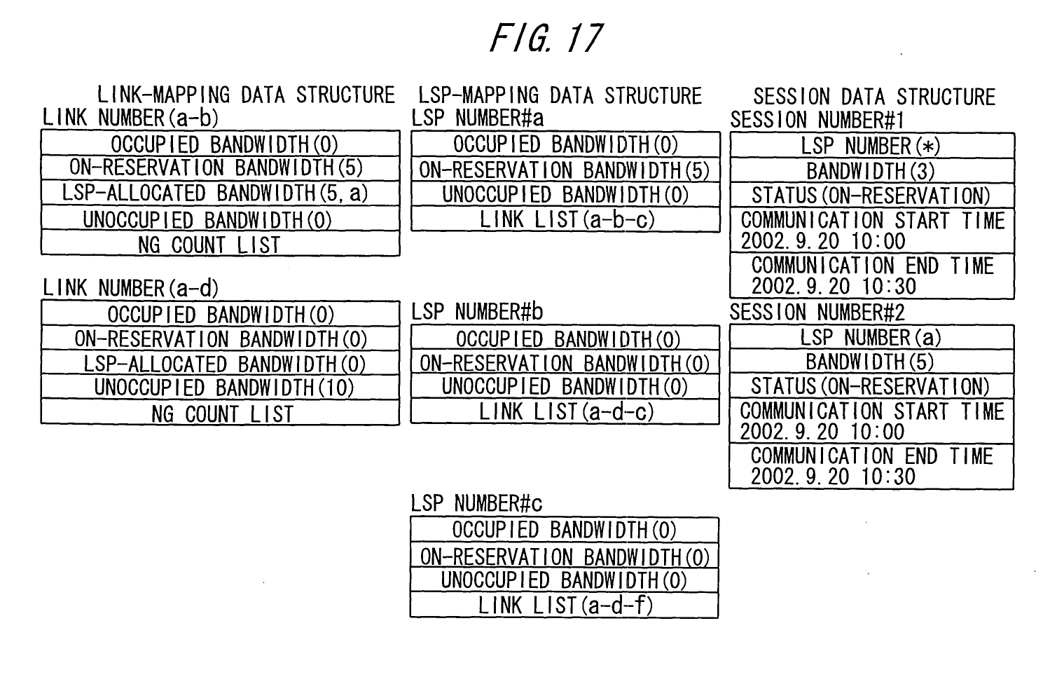

The NMS 100, the total route algorithmic process being finished (S205: Yes), judges whether there is a route on which the necessary unoccupied bandwidth exists or not (S206). Herein, as explained above, the NMS 100 judges that the necessary unoccupied bandwidth exists on each of the routes a-b-c and a-d-c (S203: Yes), and therefore sets (adds) the on-reservation bandwidth 5 in the on-reservation bandwidth 102b in the LSP-mapping data 102 for the route a-b-c (corresponding to a reservation path) exhibiting a minimum total decrement (0) (see an upper part of a central row in FIG. 17) (S207).

Next, the NMS 100 subtracts the on-reservation bandwidth 5 from the unoccupied bandwidth 101d in the link-mapping data 101 mapping to a via-link (which is a link, e.g., the link a-b of the links building up the route a-b-c), and adds the on-reservation bandwidth 5 respectively to the LSP-allocated bandwidth 101c and the on-reservation bandwidth 101b (see a lower part of a left row in FIG. 17) (S207). Through this process, it follows that the bandwidth re-allocation (reservation path re-setting) of the on-reservation bandwidth 5 is completed.

FIG. 15 shows the unoccupied bandwidths of the respective links at that time. Referring to FIG. 15, the numeral 0 on the link a-b between the nodes a-b indicates that 0 is set in the unoccupied bandwidth 101d of this link a-b. The numeral (5) adjacent thereto also indicates that 5 is set in the on-reservation bandwidth 101b of this link a-b. Other numerals have the same connotation.

Herein, the total reservation session algorithmic process is not yet finished (S208: No), the NMS 100 next repeats the following process for all the routes (the routes a-b-c and a-d-c) between the nodes a-c with respect to the session of the on-reservation bandwidth 3 (S202 through S205: No).

The NMS 100 judges whether or not a necessary unoccupied bandwidth exists on the selected route (e.g., a-b-c) (S203). For example, the NMS 100 refers to the unoccupied bandwidths 101d in the link-mapping data 101 for all the links building up the selected route a-b-c, and thus judges whether there is established this relationship: the unoccupied bandwidth 101d>=the on-reservation bandwidth 3. Referring to FIG. 15, there is not established the relationship such as the unoccupied bandwidth 101d>=the on-reservation bandwidth 3, where the unoccupied bandwidth 101d (0 is set in the unoccupied bandwidth of the link a-b, and 3 is set in the unoccupied bandwidth of the link b-c) exists in the link-mapping data 101 for the links building up the route a-b-c. Therefore, the NMS 100 judges that the necessary unoccupied bandwidth does not exist (S203; No).

The NMS 100, when judging that the necessary unoccupied bandwidth does not exist, the total route algorithmic process not being finished (S205: No), selects next a route a-d-c, and judges whether or not the necessary unoccupied bandwidth exists on this selected route a-d-c (S202, S203). For instance, the NMS 100 refers to the unoccupied bandwidths 101d in the link-mapping data 101 for all the links building up the selected route a-d-c, and thus judges whether or the there is established a relationship such as the unoccupied bandwidth 101d>=the on-reservation bandwidth 3. Referring to FIG. 15, there is established this relationship: the unoccupied bandwidth 101d>=the on-reservation bandwidth 3, where the unoccupied bandwidth 101d (10 is set in the unoccupied bandwidth of the link a-d, and 7 is set in the unoccupied width of the link d-c) exists in the link-mapping data 101 for the links building up the route a-d-c. Therefore, the NMS 100 judges that the necessary unoccupied bandwidth exists (S203: Yes).

The NMS 100, when judging that the necessary unoccupied bandwidth exists, calculates a total decrement of a maximum usable bandwidth between all other edges on the basis of the minimum interfering algorithm (S204). Assuming herein that the on-reservation bandwidth 3 is allocated to the route a-d-c, the maximum usable capacities between the respective edges (edge nodes) are given as follows. The capacity between the nodes a-c=5, the capacity between the nodes a-e=7, the capacity between the nodes a-f=7, the capacity between the nodes c-e=4, the capacity between the nodes c-f=4, and the capacity between the nodes e-f=8, wherein a total capacity is added up to 31. This indicates that the total capacity before the on-reservation bandwidth 3 is allocated to the route a-b-c is 47, and hence the total decrement is 16.

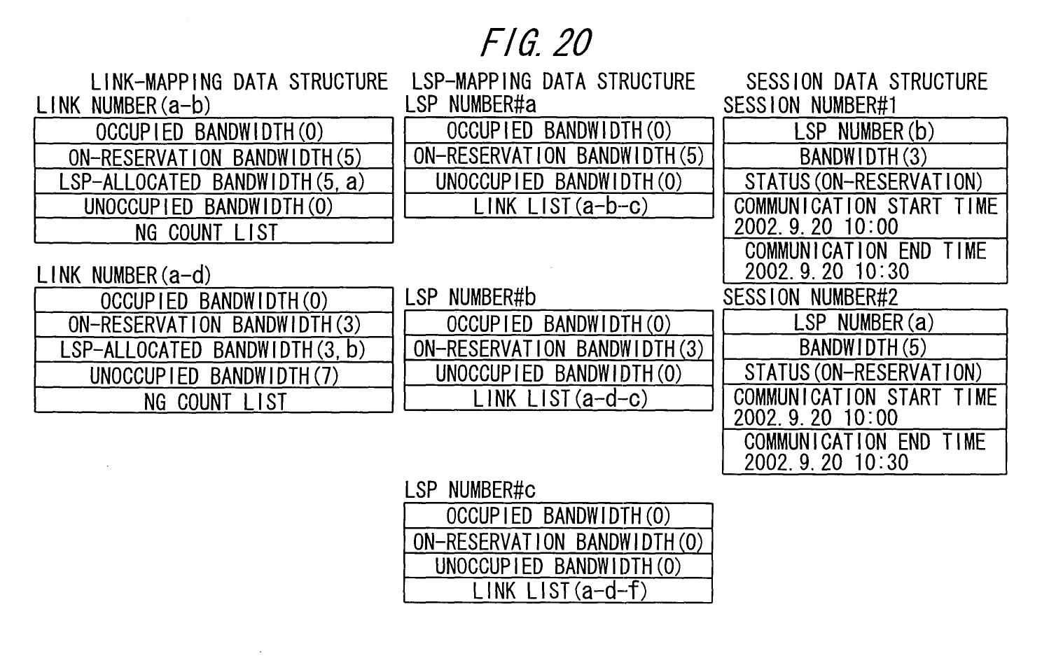

Through this process, the NMS 100, the total route algorithmic process being finished (S205: Yes), judges whether there is a route on which the necessary unoccupied bandwidth exists. Herein, as explained above, the NMS 100 judges that the necessary unoccupied bandwidth exists on the route a-d-c (S203: Yes), and therefore sets (adds) the on-reservation bandwidth 3 in the on-reservation bandwidth 102b in the LSP-mapping data 102 for the route a-d-c (corresponding to a reservation path) exhibiting a minimum total decrement (16) (see a middle part of a central row in FIG. 20) (S207).

Next, the NMS 100 subtracts the on-reservation bandwidth 3 from the unoccupied bandwidth 101d in the link-mapping data 101 mapping to a via-link (which is a link, e.g., the link a-d of the links building up the route a-d-c), and adds the on-reservation bandwidth 3 respectively to the LSP-allocated bandwidth 101c and the on-reservation bandwidth 101b (see a lower part of a left row in FIG. 20). Through this process, it follows that the bandwidth re-allocation (reservation path re-setting) of the on-reservation bandwidth 3 is completed.

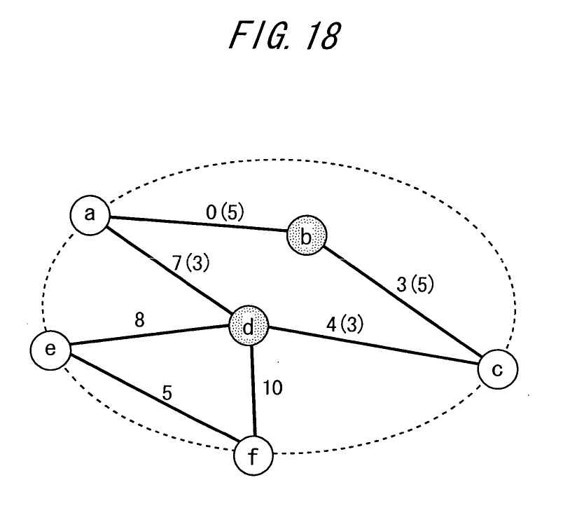

FIG. 18 shows the unoccupied bandwidths of the respective links at that time. Referring to FIG. 18, the numeral 7 on the link a-d between the nodes a-d indicates that 7 is set in the unoccupied bandwidth 101d of this link a-d. The numeral (3) adjacent thereto also indicates that 3 is set in the on-reservation bandwidth 101b of this link a-d. Other numerals have the same connotation.

Next, it is assumed that a reservation request (for reserving the session of the bandwidth 6 between the nodes a-f) has been inputted from the terminal 200 (or a different terminal) after the bandwidth re-allocations of the on-reservation bandwidths 5 and 3 have been completed. The NMS 100 accepts this reservation request (S100), and searches for and selects an unoccupied LSP (S101).

For instance, the NMS 100 refers to the unoccupied bandwidth 102c in the LSP-mapping data 102 (mapping to a route on which two end nodes are the node “a” and the node “f”), and judges whether or not there exists the LSP-mapping data 102 that meets this relationship: the unoccupied bandwidth 102c>the reservation-requested bandwidth 6 (S102). Herein, the NMS 100 that none of the LSPs are unoccupied (S102: No). When judging that there is no unoccupied LSP, the NMS 100 seeks, based on the minimum interfering algorithm, for such a route as to have a minimum total decrement.

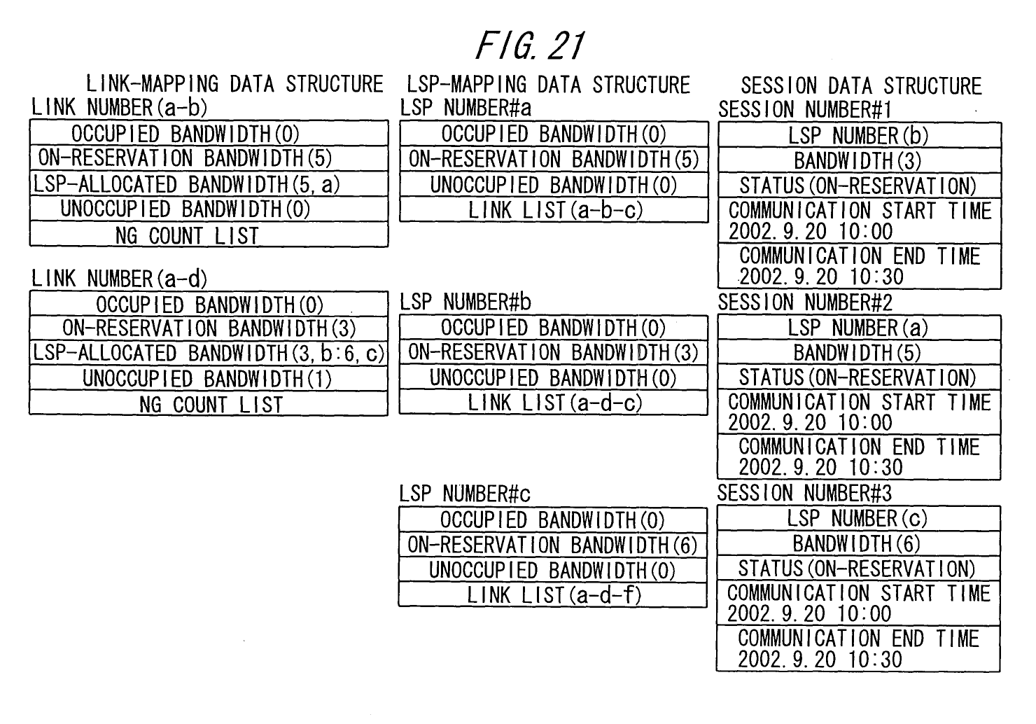

Herein, referring to FIG. 18, the reservation-requested route between the nodes a-f is only the route a-d-f. Therefore, the NMS 100 adds the reservation-requested bandwidth 6 to the on-reservation bandwidth 102b in the LSP-mapping data 102 mapping to the route a-d-f (see a lower part of a central row in FIG. 21) (S103).

Next, the NMS 100 subtracts the on-reservation bandwidth 6 from the unoccupied bandwidth 101d in the link-mapping data 101 mapping to a via-link (which is a link, e.g., the link a-d of the links building up the route a-d-f) (see a lower part of a left row in FIG. 21) (S103) Further, the NMS 100 adds the on-reservation bandwidth 6 respectively to the LSP-allocated bandwidth 101c and the on-reservation bandwidth 101b in the above link-mapping data 101 (see the lower part of the left row in FIG. 21) (S103). Through this process, it follows that the reservation-requested bandwidth 6 is successfully ensured (S104: Yes).

The NMS 100, upon succeeding in ensuring the reservation-requested bandwidth 6, sets (generates) the session data 103 mapping to the LSP for the route a-d-f (see a lower part of a right row in FIG. 21) (S105). For example, an LSP number (which is herein an LSP number #c) is set in the LSP number 103a in the session data 103 mapping to the LSP for the route a-d-f, the reservation-requested bandwidth 6 is set in the bandwidth 103b, and “on-reservation” is set in the status 103c, respectively (see the lower part of the right row in FIG. 21). Further, the NMS 100 sets (timer registration) the communication start time 103d and the communication end time 103e in the session data 103 (S106). Upon a completion of the settings described above, the NMS 100 notifies the terminal 200 that the reservation is OK.

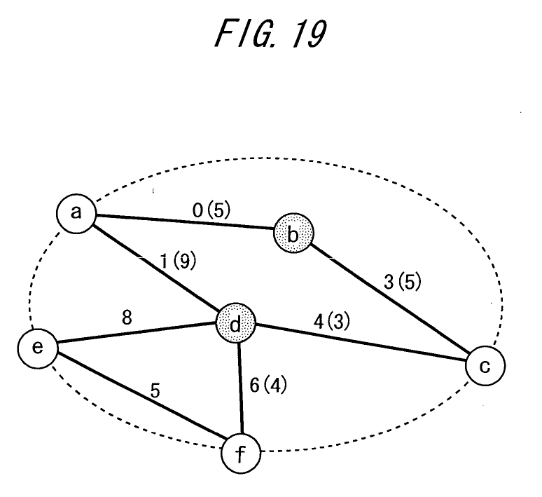

FIG. 19 shows the unoccupied bandwidths of the respective links after the session of the bandwidth 6 has been, as described above, reservation-set between the nodes a-f. The numeral 1 on the link a-d between the nodes a-d in FIG. 19 indicates that 1 is set in the unoccupied bandwidth 101d of that link a-d. Further, (9) adjacent thereto shows that 9 is set in the on-reservation bandwidth 101b of the same link a-d. Other numerals have the same connotation.

As discussed above, according to the reservation path optimization method in this embodiment, the LSP (corresponding to the reservation path) 102d is periodically re-set (re-routing) based on the bandwidth 103b (including other items such as the unoccupied bandwidth of each link, etc.), thereby optimizing the reservation path. Hence, as compared with the network utilizing the present system, a resource activity efficiency is improved. Further, there decreases a probability that the reservation is rejected due to the deficiency of the resources when making the reservation.

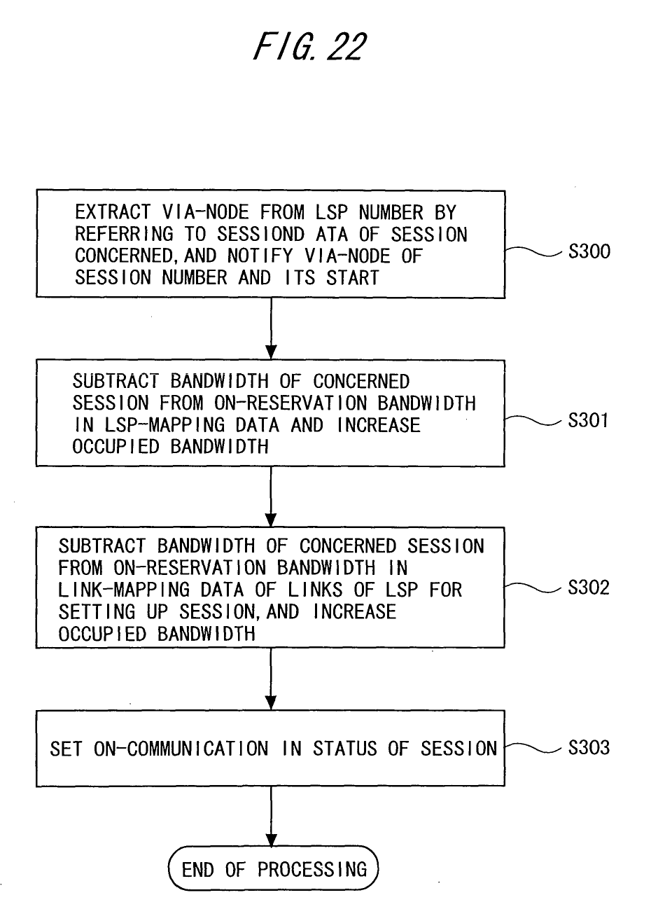

Next, a process of starting the on-reservation session will be discussed with reference to the drawings. FIG. 22 is an explanatory flowchart showing the process of starting the on-reservation session. The process in this flowchart is executed just when reaching the communication start time 103d. The process of starting the session of the bandwidth 3 between the nodes a-c as an on-reservation session, will hereinafter be explained (the process is the same with the session of the bandwidth 5, etc.).

Just when reaching the communication start time 103d set for the on-reservation session, the NMS 100 executes the following steps (1) through (3) (S300). (1) The NMS refers to an LSP number 103a[(a)] in the session data 103 mapping to the on-reservation session. (2) The NMS 100 extracts the via-nodes (the nodes a, b, and c) out of the LSP-mapping data 102 specified by the LSP number 103a [(a)] that has been referred to. (3) The NMS 100 notifies these nodes of a session number [#1] and the start of the session as well.

Next, the NMS 100 subtracts a bandwidth 103b[3] of the on-reservation session from the on-reservation bandwidth 102b in the LSP-mapping data 102 (S301). Further, the NMS 100 adds the bandwidth 103b[3] of the on-reservation session to the occupied bandwidth 102a in the LSP-mapping data 102 (S301).

Subsequently, the NMS 100 subtracts the bandwidth 103b[3] of the on-reservation session from the on-reservation bandwidth 101b in the link-mapping data 101 mapping to each of the links building up the LSP employed by this session (S302). Further, the NMS 100 adds the bandwidth 103b[3] of the on-reservation session to the occupied bandwidth 101a in the link-mapping data 101 (S302) Ensuingly, the NMS 100 sets [on-communication] in the status 103c of this on-reservation session. Through the process described above, the on-reservation session is started.

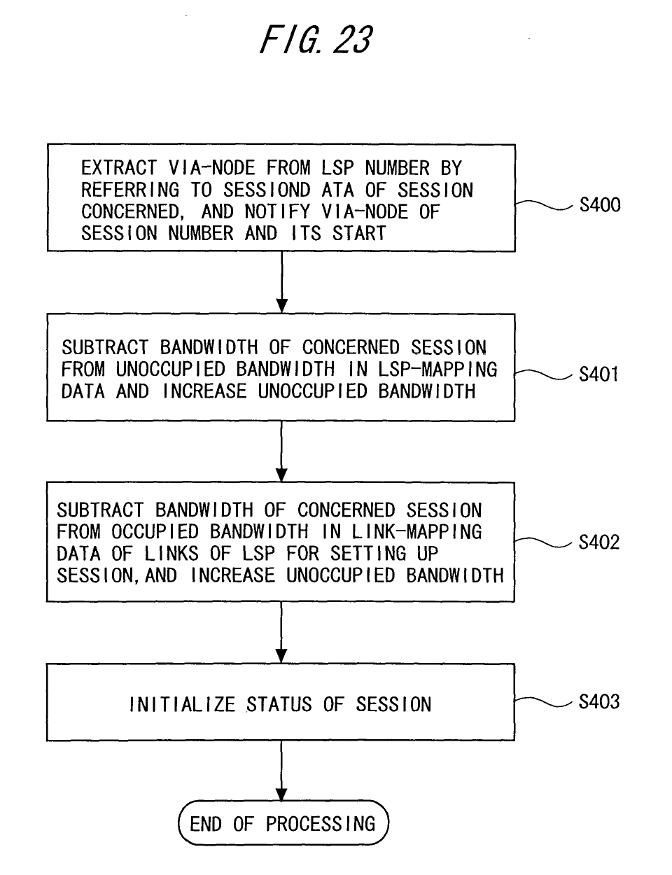

Next, a process in the case of reaching the communication end time 103e set for the on-reservation session, will be explained with reference to the drawings. FIG. 23 is an explanatory flowchart showing this process. The process in this flowchart is executed just when reaching the communication end time 103e set for the on-reservation session.

The process of terminating the session of the bandwidth 3 between the nodes a-c as the on-reservation session, will hereinafter be explained (the process is the same with the session of the bandwidth 5, etc.). Just when reaching the communication end time 103e set for the on-reservation session (the session has already been started by the process in the flowchart in FIG. 22), the NMS 100 executes the following steps (1) through (3) (S400).

(1) The NMS refers to an LSP number 103a[(a)] in the session data 103 mapping to this on-reservation session.

(2) The NMS 100 extracts the via-nodes (the nodes a, b, and c) out of the LSP-mapping data 102 specified by the LSP number 103a[(a)] that has been referred to. (3) The NMS 100 notifies these nodes of the session number [#1] and the end of the session as well.

Next, the NMS 100 subtracts the bandwidth 103b[3] of the on-reservation session from the occupied bandwidth 102a in the LSP-mapping data 102 (S401). Further, the NMS 100 adds the bandwidth 103b[3] of the on-reservation session to the unoccupied bandwidth 102c in the LSP-mapping data 102 (S401).

Subsequently, the NMS 100 subtracts the bandwidth 103b[3] of the on-reservation session from the occupied bandwidth 101a in the link-mapping data 101 mapping to each of the links building up the LSP employed by this session (S402). Further, the NMS 100 adds the bandwidth 103b[3] of the on-reservation session to the unoccupied bandwidth 101d in the link-mapping data 101 (S402). Then, the NMS 100 initializes the status of the on-reservation session (S403). Through the process described above, the on-reservation session is terminated.

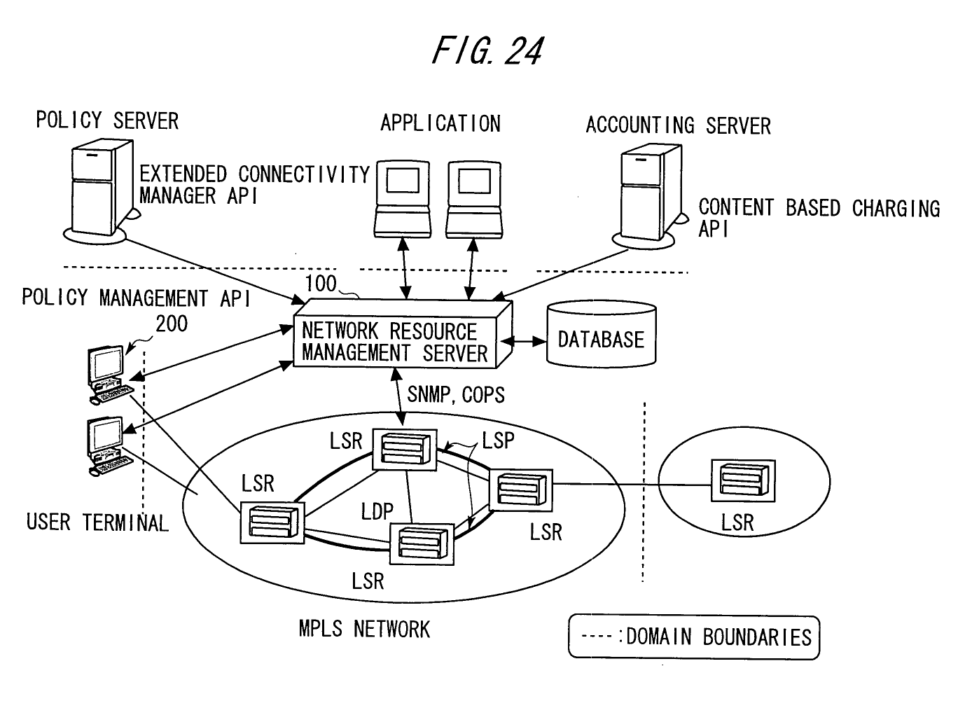

Next, an example where the reservation path optimization system described above is applied to a real system, will be discussed with reference to the drawings. FIG. 24 is an explanatory view showing the example the network management system is applied to the real system.

The present system includes, in addition to the MPLS network, the NMS 100 and the terminals 200, a policy server, an accounting server, various categories of applications and an open API (Application Programming Interface). The NMS 100, as described above, performs scheduling, including the reservation sessions of the respective resources, and thus controls the respective nodes (routers) by utilizing SNMP (Simple Network Management Protocol) when starting and finishing a reservation time. A user is able to register and change the reservation or to check a reservable time in a way that searches for an unoccupied bandwidth by accessing the NMS 100.

The present invention can be embodied in a variety of forms without departing from the spirit and the principal features of the present invention. Therefore, the embodiments discussed above are just exemplifications in every point of view and should not be construed limitedly. In particular, GMPLS (Generalized Multi-Protocol Label Switching) may be used as an extended version of MPLS, and a light wavelength may be assigned by way of a label.

As discussed above, according to the present invention, the re-routing including the on-reservation bandwidth is performed, whereby the resource activity efficiency is improved as compared with the networks that do not utilize the present system.

What is claimed is:

1. A resource management method for managing resources in a label switching network, comprising:
retaining a bandwidth of an on-reservation session and a bandwidth of an on-communication session; and
executing periodical re-setting of a path with respect to the bandwidth occupied by the on-reservation session.

2. A resource management method in a label switching network according to claim 1, further comprising:
recording a failure count, for a fixed period, of a link causing a failure in a reservation request in a previous period; and
fluctuating a weight of the link that tends to cause the failure on the basis of a history of the failure count.

3. A resource management method in a label switching network according to claim 1, further comprising fluctuating a re-setting period of the path in accordance with the reservation request failure count.

4. A reservation path optimization system for optimizing a reservation path between specified nodes configuring a network, comprising:
a reservation path setting module for setting the reservation path and a bandwidth for establishing a predetermined session between specified nodes; and
a reservation path re-setting module for periodically re-setting the reservation path on the basis of the bandwidth set by said reservation path setting module.

5. A reservation path optimization system for optimizing a reservation path between specified nodes configuring a label switching network, comprising:
a reservation path setting module for setting the reservation path and a bandwidth for establishing a predetermined session between specified nodes; and
a reservation path re-setting module for re-setting the reservation path set by said reservation path setting module.

6. A reservation path optimization system according to claim 5, the reservation path re-setting module periodically re-sets the reservation path on the basis of the bandwidth set by said reservation path setting module.

7. A reservation path optimization system according to claim 5, the reservation path re-setting module periodically re-sets the reservation path on the basis of specified algorithm

8. A reservation path optimization system according to claim 4, further comprising a module for fluctuating the period.

9. A reservation path optimization system according to claim 4 or 5, wherein the label switching network is an MPLS network, and the reservation path is Label Switched Path.

10. A reservation path optimization method for optimizing a reservation path between specified nodes configuring a network, comprising:
setting the reservation path and a bandwidth for establishing a predetermined session between specified nodes; and
periodically re-setting the reservation path on the basis of the bandwidth set by said reservation path setting.
